(19) United States
(12) Patent Application Publication
(10) Pub. No.: US 2006/0100817 A1
(43) Pub. Date: May 11, 2006

(54) Related method and device for counting according to movement of an object

(76) Inventors: SHR-JIE YOU, I-Lan Hsien (TW); TSE-HWA HAO, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/906,865

(22) Filed: Mar. 9, 2005

(30) Foreign Application Priority Data
Nov. 3, 2004 (TW) 093133524

(51) Int. Cl. G01P 15/00

(52) U.S. Cl. 702/141

(57) ABSTRACT

A method for counting according to movement of an object includes the following steps, sensing movement of the object, transferring the movement of the object into a corresponding sensing signal, and when the sensing signal includes a first waveform including a first relative extreme value and two neighboring relative extreme values and a second waveform including a second relative extreme value and two neighboring relative extreme values, wherein the difference between one of the two neighboring relative extreme values with the first relative extreme value or the second relative extreme value, is less than a predetermined value, and the first waveform and the second waveform will combined with other ungrouped waveforms to determine whether a count value should be updated, according to the updated count value of the first waveform and the second waveform.

### BACKGROUND OF INVENTION

1. Field of the Invention

The present invention relates to a method and device for counting according to movement of an object, and more particularly, to a method and device for determining the waveform of a sensor signal according to movement of an object.

2. Description of the Prior Art

A pedometer is a small accessory for counting steps taken and is worn on the human body. From a sanitary and health prospective, the function of the pedometer is to record a number of steps taken within a period of time. The aim is to improve health by counting the number of steps taken to understand the body's level of movement and the motivation of the individual. In addition to counting paces, some pedometers can also input a user's weight to estimate a number of calories burned from the total steps taken. After a walk, the user can set a target for dieting according to the calories burned and also reference figures can be set according the number of steps taken and the number of calories burned.

The sensor value created by the sensor of the pedometer is very different during walking or running. In general, the speed of walking is slow and step vibration is smaller; also the external force created on the sensor is not as severe. The speed of running is faster and hence the vibration is bigger, and the external force created on the sensor is more severe. Please refer to FIG. 1 and FIG. 2. FIG. 1 illustrates a waveform diagram of a corresponding sensor signal converted from the movement of walking. FIG. 2 illustrates a waveform diagram of a corresponding sensor signal converted from the movement of running. The amplitude of the waveform in FIG. 1 is smaller than the amplitude of the waveform in FIG. 2, and the variation of the sensor signal in FIG. 2 is bigger than the variation of the sensor signal FIG. 1. The accuracy of counting steps can be affected by noise in the sensor signal detected by the pedometer, especially during the movement of walking. Therefore the problem is how to effectively count the number of steps taken by the user and how to improve on the prior art.

### SUMMARY OF INVENTION

The claimed invention relates to a method for counting according to movement of an object to solve the above-mentioned problems.

One embodiment of the claimed invention comprises a method of updating a counter according to a movement of an object and the method comprising the following steps: sensing movement of the object, transferring movement of the object into a corresponding sensor signal, and a sensor signal comprises a first waveform and a second waveform; the first waveform includes a first relative extreme value and two neighboring relative extreme values; the second waveform includes a second relative extreme value and two neighboring relative extreme values; the difference between one of the first neighboring relative extreme values and the first relative extreme value is less than a predetermined value, the difference between one of the neighboring relative extreme values and the second relative extreme value is less than the predetermined value, combining the first waveform and the second waveform with other ungrouped waveforms to determine whether a counter should be updated according to the first waveform and the second waveform.

A counting device of updating count value of movement of an object comprises a sensor unit for sensing the movement of the object and converting the movement into a corresponding sensor signal, and a processing unit for updating a counter according to a first waveform formed by a first relative extreme value and two neighboring relative extreme values and a second waveform formed by a second relative extreme value and two neighboring relative extreme values, wherein the difference between one of the neighboring relative extreme values with the first relative extreme value is less than a predetermined value, the difference between one of the neighboring relative extreme values with the second relative extreme value is less than the predetermined value, and the first waveform and the second waveform have not combined with other ungrouped waveforms to determine whether the count value should be updated.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a waveform diagram of a sensor signal converted from the movement of walking.

FIG. 2 illustrates a waveform diagram of a sensor signal converted from the movement of running.

FIG. 3 illustrates a functional block diagram of a counting device.

FIG. 4 illustrates a flowchart of a counting device updating a count value according to movement of an object.

FIG. 5 illustrates a waveform diagram formed by five digital sensor values.

FIG. 6 illustrates a waveform diagram of four types of count unit formed by digital sensor value.

FIG. 7 to FIG. 9 illustrate waveform diagrams of the count logic unit according to the present invention

FIG. 10 illustrates waveform diagrams formed by a count logic unit group M, N, O, P according to FIG. 9

FIG. 11 illustrates a diagram of waves formed by digital sensor values.

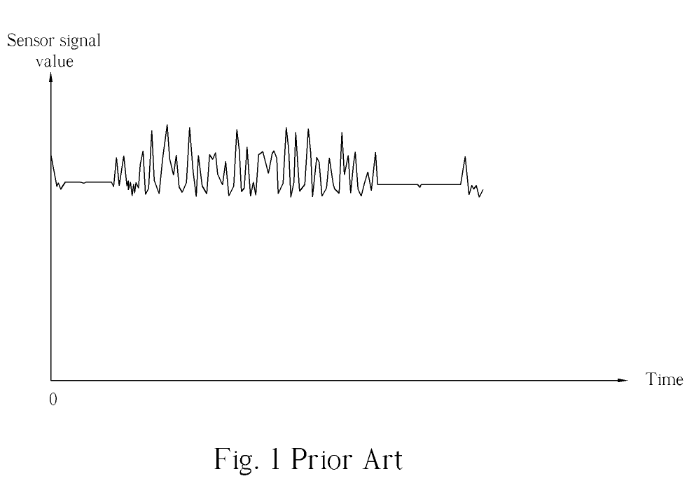

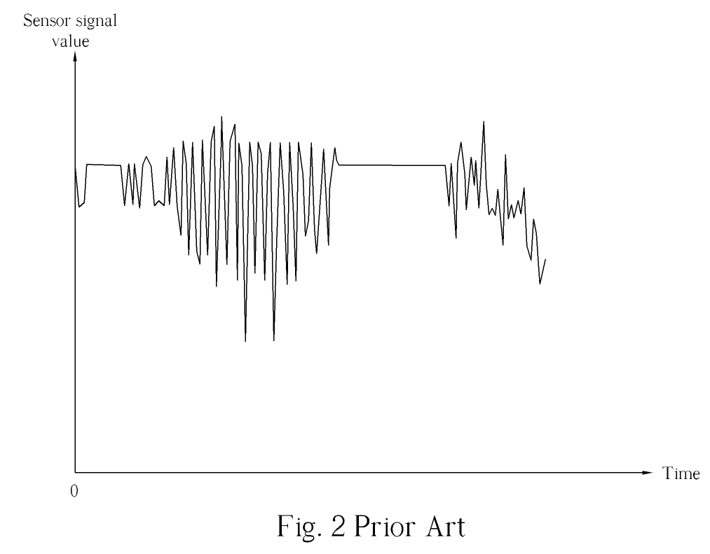

### DETAILED DESCRIPTION

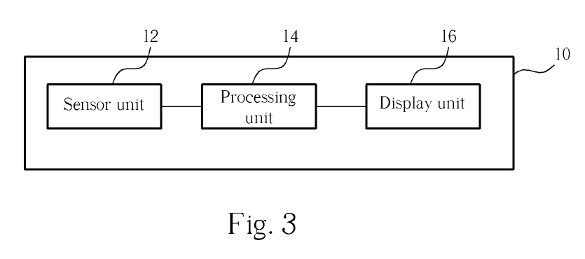

Please refer to FIG. 3. FIG. 3 illustrates a functional block diagram of a counting device 10. The counting device 10 can be used for counting according to the movement of an object. The counting device can be a pedometer for counting steps of the user when walking or running according to the movement of the user. The counting device 10 comprises a sensor unit 12 for sensing movement of the object and which converts the movement into a corresponding sensor signal, for example when sensing the acceleration value of the user (either walking or running) and the acceleration value is converted into a corresponding sensor signal. The counting device 10 further comprises a processing unit 14, coupled to the sensor unit 12, for updating the count value of the counting device 10, and a display unit 16, coupled to the processing unit 14, for receiving the corresponding sensor signal from the processing unit 14 to display the count value, for example letting the user know the number of steps accumulated in the counting device through the display unit 16.

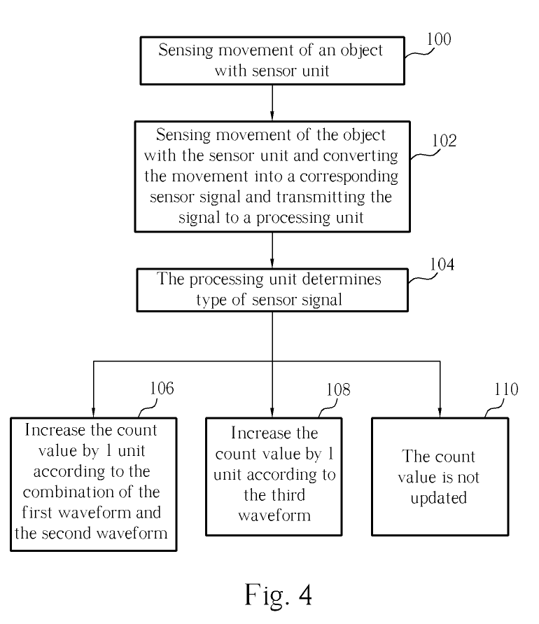

Please refer to FIG. 4. FIG. 4 illustrates a flowchart of a counting device 10 updating its count value according to the movement of an object comprising the following steps:

Step 100: sensing movement of an object with sensor unit 12

Step 102: sensing movement of the object with the sensor unit 12 and converting the movement into a corresponding sensor signal and transmitting the signal to a processing unit 14.

Step 104: the processing unit 14 determines type of sensor signal, when the sensor signal including a first waveform formed by a first relative extreme value and two neighboring relative extreme values; the second waveform is formed by a second relative extreme value and two neighboring relative extreme values; the difference between one of the neighboring relative extreme values with the first relative extreme value is less than a predetermined value, the difference between one of the neighboring relative extreme values and the second relative extreme value is less than the predetermined value, and the first waveform and the second waveform have not combined with other ungrouped waveforms to determine whether a count value should be updated, execute step 106; a third waveform formed by a third extreme value and two neighboring extreme values, the differences between each of the neighboring relative extreme values and the third extreme value are less than the predetermined value, execute step 108; a fourth waveform formed by a fourth extreme value and two neighboring extreme values, the differences between each of the neighboring relative extreme values and the fourth extreme value are less than the predetermined value, execute step 110.

Step 106: increase count value by 1 unit according to the combination of the first waveform and the second waveform.

Step 108: increase the count value by 1 unit according to the third waveform.

Step 110: the count value is not updated.

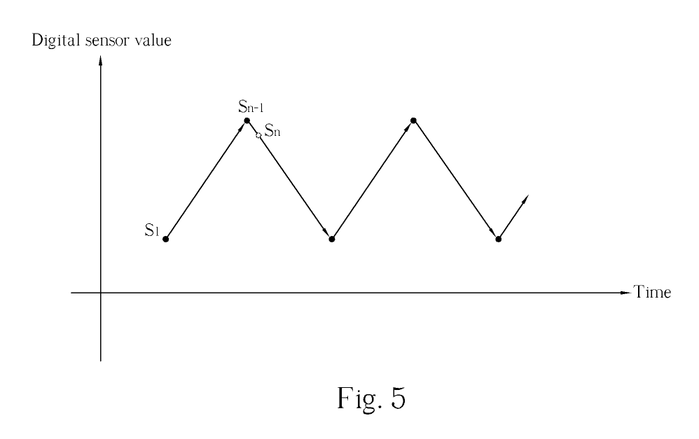

To further explain the steps above, for example, when the sensor unit is sensing the acceleration of the user during each time period, it utilizes rule of acceleration to convert the acceleration into a corresponding potential value. Lastly, the potential value is converted to a digital sensor value processed by the processing unit 14. The method of sampling the digital sensor value uses five digital sensor values as one count logic unit. The method first takes down the digital sensor value S1 at time T1, followed by a time interval (which can be set by user), and the digital sensor value S2 at time T2. If the digital sensor value B is greater than the digital sensor value A, then the digital sensor values A and B will be stored into the buffer 10 of the counting device 10, followed by the time interval. The digital sensor value S3 at time T3 is captured, and if the digital sensor value S3 is greater than S2, S3 will be stored into the buffer 10 to replace S2 and S2 will then be deleted. The following steps mentioned above will be repeated until when n number of times at time Tn the digital sensor value Sn is less than previous (n−1 number of times) at time Tn−1 the digital sensor value Sn−1, the previous digital value Sn−1 at Tn−1 time will be stored into the buffer. The digital sensor values S1 and Sn−1 are stored in the buffer. If in the continuing time intervals, the digital sensor values captured are less than Sn−1, then these lesser values will not be taken in account, until when a digital sensor value is greater than Sn−1, the previous digital sensor value will be stored into the buffer. Similarly, a wave crest and a wave trough of the digital sensor value can be obtained, and so the five digital sensor values are captured and sampled as a count logic unit. Please refer to FIG. 5, which illustrates a waveform diagram formed by five digital sensor values of the above-mentioned, but there are also other ways in accomplishing this not limited only to the method mentioned above.

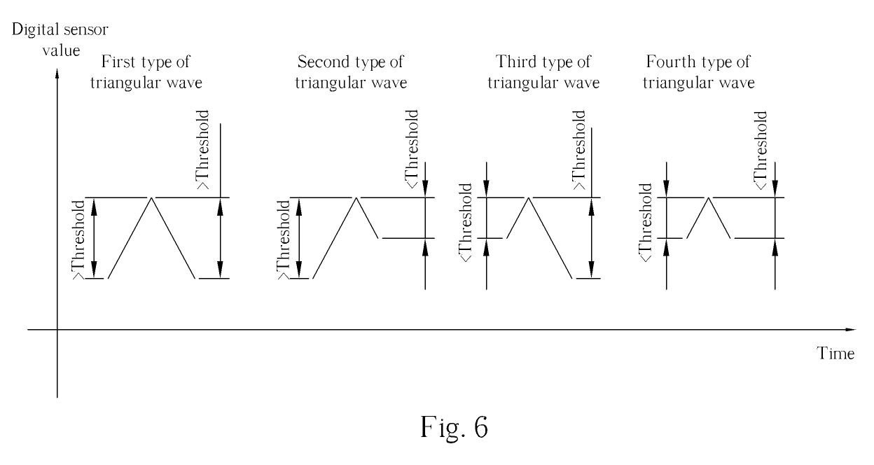

Please refer to FIG. 6. FIG. 6 illustrates a waveform diagram of four types of count units formed by the digital sensor value. As shown in FIG. 6, the count unit formed by the digital sensor value is a triangular wave. As to how the four types of count units can be determined and included into new count value, a threshold is set as criteria. When the difference between two relative minimum value and one relative maximum value of the triangular wave is greater than the threshold, as shown in the first type of triangular wave of FIG. 6, the said triangular wave can be determined as a count value, and the processing unit 14 can update the count value according to the triangular wave signal, for example the accumulated count value plus one. But when the difference between two relative minimum values and one relative maximum value of the triangular wave is less than the threshold, as shown in the fourth type of triangular wave of FIG. 6, the said triangular wave cannot be determined as a count value, which also means that the processing unit 14 will view the said triangular wave as noise and will not update the count value; within the two relative minimum values of the triangular wave, if the difference between one of the relative minimum values and the relative maximum value is greater than the threshold and the difference between the other relative minimum value and the relative maximum value is less than the threshold, as shown in the second and third type of triangular wave of FIG. 6, this means that there may be a micro-vibration (second type of triangular wave) or an ending micro-vibration (fourth type of triangular wave), and hence the processing unit 14 combines the triangular wave and other ungrouped neighboring waveforms to determine whether there is the second or third type of triangular waves formed to update the count value according to the group result.

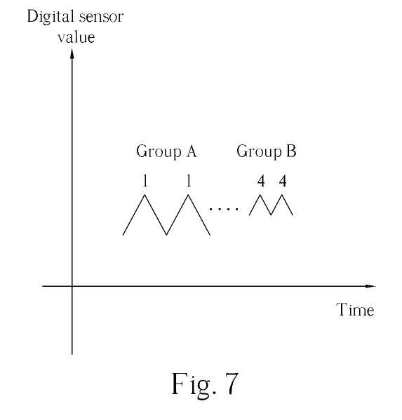

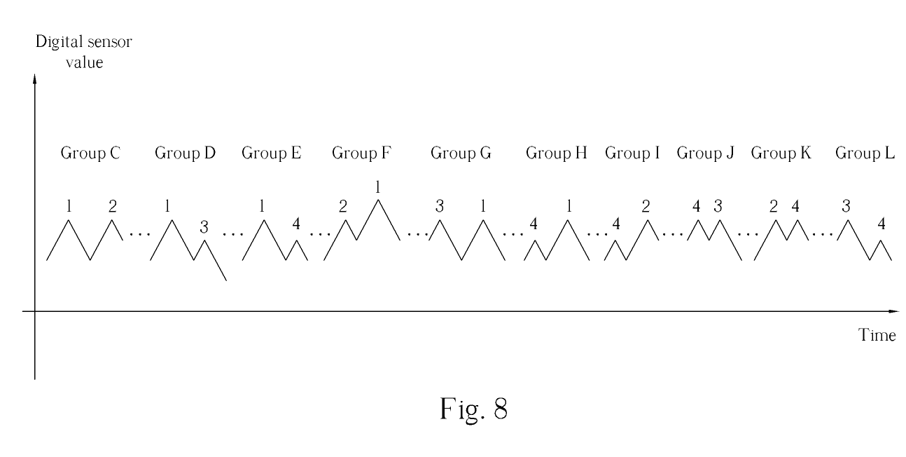

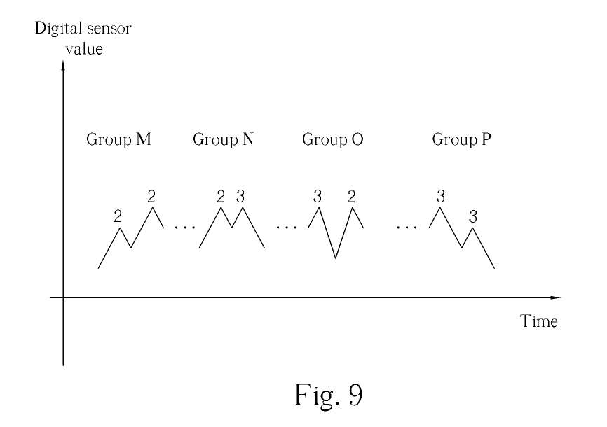

If the four types of count value form into two groups with each other, 16 (4*4) combinations with two triangular waves can be formed and these combinations are the count logic unit of the present invention, as to the method of capturing five digital sensor values to become a count logic unit is the same as the above-mentioned. Please refer to FIGS. 7-9. FIGS. 7-9 illustrate waveform diagrams of the count logic unit according to the present invention. Referring to FIG. 7 in combination with FIG. 6, FIG. 7 displays a group A of two first type of triangular waves and a group B of two fourth type of triangular waves. When the sensor unit 12 produces group A or group B like in FIG. 7, the processing unit 14 can directly update the count value according to group A, for example by increasing the accumulated count value by 2 units, or the processing unit 14 can directly ignore group B and not update the count value. Referring to FIG. 8 in combination with FIG. 6, FIG. 8 illustrates combinations of the first and second types, first and third types, and first and fourth types of triangular waves of FIG. 6 to form groups C, D, and E respectively. FIG. 8 further illustrates the second type and the first type of triangular wave of FIG. 6 to form group F, the third type and the first of triangular wave of FIG. 6 to form group G. FIG. 8 illustrates combinations of the fourth and first types, fourth and second types, and fourth and third types of triangular waves of FIG. 6 to form groups H, I, and J respectively. FIG. 8 further illustrates a combination of the second type and the fourth type of triangular wave of FIG. 6 to form group K, and a combination of the third type and the fourth type of triangular waves of FIG. 6 to form group L. When the group of triangular waves of the first type and the fourth type generated by the sensor unit 12, such as group E and H, the processing unit 14 considers only the first type of triangular wave to update the count value and ignores the fourth type. For example, when the accumulated count value is 1, and when a group of triangular waves of the first type and the second or third type are generated by the sensor unit 12, such as groups C, D, F, G, the processing unit 14 considers the first type of triangular wave to increase the accumulated count value of 1 and the rest of the second or third type will combine with other ungrouped second or third type triangular waves to determine count value. When a group of triangular waves of the fourth type and the second or third types are generated by the sensor unit 12, such as groups I, J, K, and L, the processing unit 14 will ignore the fourth type of triangular wave and not update the accumulated count value, and the rest of the second or third types will combine with other ungrouped second or third type triangular waves to determine the count value. Please refer to FIG. 6 and FIG. 9. FIG. 9 illustrates the groups M, N, O, P formed by combinations of the second and third types of triangular waves of FIG. 6. In groups C to L of FIG. 8, the first type is eliminated and increases the accumulated count value of 1 or the fourth type is eliminated and the accumulated count value is not increased. The rest of the second or third type can combine with other ungrouped second or third type of triangular waves to determine the count value, and hence also form groups M, N, O, P of FIG. 9. Only the count logic units group A and B of FIG. 7 are able to determine directly whether the count value is to be updated; the count logic unit groups C through L of FIG. 8 need to be converted to forms of the groups M, N, O, P in order to determine count value.

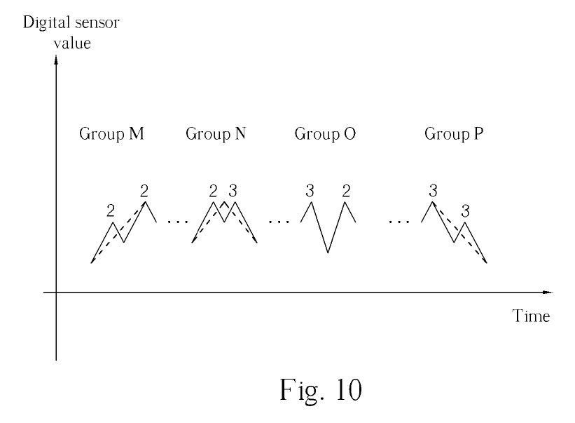

Please refer to FIG. 10. FIG. 10 illustrates waveform diagrams formed by count logic unit group M, N, O, and P according to FIG. 9. Looking at FIG. 10, although groups M, N, O, P are formed by two triangular waves (the second and third type of triangular waves), in practice, in order to avoid noise affecting the determine of count value, the four types of group can be considered to have an effective count wave output, as shown in the dotted line in FIG. 10, such that the second and the third triangular waves are able to form an effective count wave. Hence the processing unit 14 increases the accumulated count value by 1 unit according to determining the groups M, N, O, P, and even if there are two effective count waves, the accumulated count value will not be increased by 2 units.

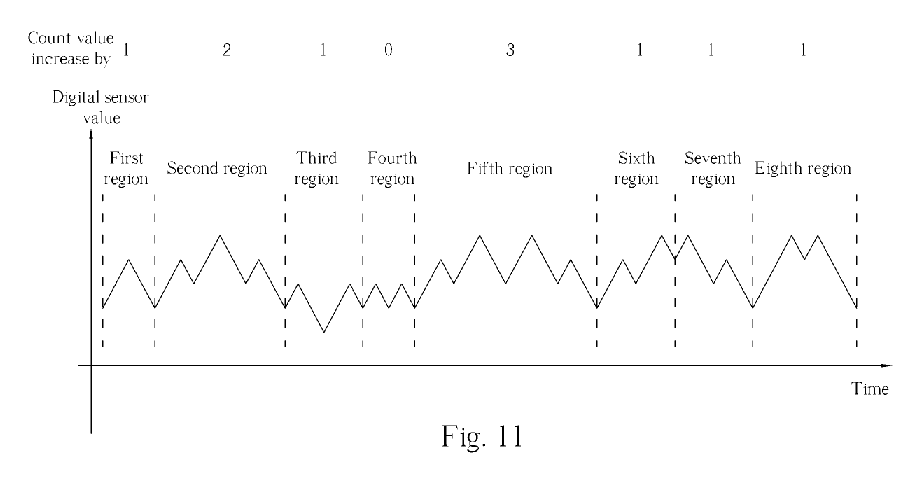

Waves formed by the digital sensor value generated by the sensor unit 12 can be formed by the count unit or the count logic unit in the above-mentioned manner, which also means that any wave can be reduced to groups of count units or count logic units. Please refer to FIG. 11, which illustrates a diagram of waves forming a digital sensor value. As shown in FIG. 11, the digital sensor value at different times changes its corresponding volume, and a string of waves formed by the digital sensor value basically can be divided into eight regions. The principle of the regions divided follows according to the above-mentioned method of the count logic unit determining the update of the count value. The first region is a first type of triangular wave able to increase count value by 1 unit; the second region is a group F with a third type of triangular wave able to eliminate the first type of triangular wave and increase the count value by 1 unit. Then the second and third types of triangular wave combine to form group N, hence increasing the count value by 1 unit, which means that the count value of the second region increases by a total of 2 units; the third region is group O and the count value increases by 1 unit; the fourth region is a group B and the count value is not increased; the fifth region is a group F and a group D, wherein the first type of triangular wave of group F is first eliminated and the count value is increased by 1 unit, and then the first type of triangular wave of group F is also eliminated and the count value is increased by 1 unit, and the second type of triangular wave of group F and the third type of triangular wave of group D combine to form group N, hence increasing the count value by 1 unit, which means that the count value of the fifth region increase by a total of 3 units; the seventh region is group P and the count value is increased by 1 unit; the eighth region is group N and the count value is also increased by 1 unit. To conclude the above-mentioned, in FIG. 11 the digital sensor signal totals to a count value by 10 units (1+2+1+0+3+1+1+1).

In comparison with the prior counting device, the present invention is capable of determining the waveform of a sensor signal according to the movement of an object to update count value, and accordingly the method and count logic unit of the present invention can effectively eliminate noise affecting the count, especially with the improvement in narrowing the variation of movement in walking of the sensor signal, hence the present invention can effectively improve on the current count technology and increase the accuracy of counting steps.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of updating a counter according to a movement of an object, the method comprising the following steps:
(a) sensing the movement of the object;
(b) transforming movement of the object into a corresponding sensor signal, and;
(c) when a sensor signal comprises a first waveform and a second waveform, the first waveform comprises a first relative extreme value and two first neighboring relative extreme values, the second waveform comprises a second relative extreme value and two second neighboring relative extreme values, the difference between one of the first neighboring relative extreme values with the first relative extreme value is less than a predetermined value, and the difference between one of the second neighboring relative extreme values with the second relative extreme value is less than the predetermined value, combining the first waveform and the second waveform with other ungrouped waveforms to determine whether a counter should be updated according to the first waveform and the second waveform.

2. The method of claim 1 wherein step (a) is sensing an acceleration value of the movement of the object, and step (b) is transforming the acceleration value into a corresponding sensor signal.

3. The method of claim 1 wherein step (c) further comprises combining the first waveform and the second waveform to update the count value.

4. The method of claim 1 further comprising step (d) wherein a sensor signal comprises a third waveform formed by a third extreme value and two neighboring extreme values, when the differences between each of the neighboring relative extreme values and the third extreme value are greater than the predetermined value, the count value is updated according to the third waveform.

5. The method of claim 4 wherein the third waveform is a triangular waveform.

6. The method of claim 1 further comprising step (e) wherein a sensor signal comprises a fourth waveform formed by a fourth extreme value and two neighboring extreme value, when the differences between each of the neighboring relative extreme values and the fourth extreme value are less than the predetermined value, the fourth waveform is not included into the updated count value.

7. The method of claim 6 wherein the fourth waveform is a triangular waveform.

8. The method of claim 1 wherein the first waveform and the second waveform are triangular waveforms.

9. A counting device of updating count value of movement of an object comprising:
a sensor unit for sensing the movement of the object and converting the movement into a corresponding sensor signal; and
a processing unit coupled to a sensor unit for updating a counter according to a first waveform formed by a first relative extreme value and two neighboring relative extreme values and a second waveform formed by a second relative extreme value and two neighboring relative extreme values, wherein the difference between one of the neighboring relative extreme values and the first relative extreme value is less than a predetermined value, the difference between one of the neighboring relative extreme values and the second relative extreme value is less than the predetermined value, and the first waveform and the second waveform have not combined with other ungrouped waveforms to determine whether the count value should be updated.

10. The counting device of claim 9 wherein the sensor unit senses an acceleration value of the movement of the object, and converts the acceleration value into a corresponding sensor signal.

11. The counting device of claim 9 wherein the counting device is a pedometer.

12. The counting device of claim 9 wherein the processing unit updates the count value according to the combination of the first waveform and the second waveform.

13. The counting device of claim 9 wherein the processing unit is used wherein a sensor signal comprises a third waveform formed by a third extreme value and two neighboring extreme values, when the difference between each of the neighboring relative extreme values and the third extreme value are greater than the predetermined value, the count value is updated according the third waveform.

14. The counting device of claim 9 wherein the processing unit is used wherein a sensor signal comprises a fourth waveform formed by a fourth extreme value and two neighboring extreme values, when the differences between each of the neighboring relative extreme values and the fourth extreme value are less than the predetermined value, the fourth waveform is not included into the updated count value.

15. The counting device of claim 9 further comprising:
a display unit coupled to the processing unit for displaying the count value.
